(19) United States
(12) Patent Application Publication
(10) Pub. No.: US 2026/0258804 A1
(43) Pub. Date: Sep. 3, 2026

(54) ELECTRIC WATER PUMP WITH DIRECT TERMINAL

(71) Applicant: COAVIS, Sejong-si (KR)

(72) Inventors: Hyuntae Lee, Sejong-si (KR); Wookeun Lee, Sejong-si (KR); Yonghwan Choi, Daejeon (KR)

(21) Appl. No.: 19/439,182

(22) Filed: Jan. 2, 2026

(30) Foreign Application Priority Data
Jan. 3, 2025 (KR) 10-2025-0000796

(51) Int. Cl. F04D 13/06

(52) U.S. Cl. CPC F04D 13/0693

(57) ABSTRACT

The present disclosure relates to an electric water pump that can increase volumetric efficiency and enhance connection stability through a direct connection-type terminal. More specifically, the electric water pump may include: a stator including a rotor accommodating portion configured to accommodate a rotor and a plurality of coils arranged in a circumferential direction around a rotational shaft of the rotor; and a terminal coupled to a side of the stator and electrically connected to the plurality of coils, wherein the terminal may include a direct terminal interposed inside the stator in direct contact with the plurality of coils.

### CROSS-REFERENCE TO RELATED APPLICATIONS

This application claims priority under 35 U.S.C. § 119 to Korean Patent Application No. 10-2025-0000796, filed on Jan. 3, 2025, in the Korean Intellectual Property Office, the disclosure of which is incorporated herein by reference in its entirety.

### TECHNICAL FIELD

The following disclosure relates to an electric water pump with a direct terminal, and more specifically, to an electric water pump capable of increasing volumetric efficiency and enhancing connection stability through a direct connection-type terminal.

### BACKGROUND

A water pump is a device for circulating coolant to an engine or a heater to cool the engine or heat the interior. Such water pumps are broadly divided into a mechanical water pump and an electric water pump.

A mechanical water pump is a pump that is connected to the crankshaft of an engine and is driven by rotation of the crankshaft, and an electric water pump is a pump that is driven by rotation of a motor that is controlled by a control device.

Here, since the electric water pump can be driven by electricity regardless of rotation of an engine, it has advantages in that control is easy and a flow rate of a coolant is easy to adjust, and therefore the proportion of electric water pumps being applied to vehicles is increasing.

The electric water pumps of the related art employ a method of rotating a rotor by supplying current to a coil formed around the rotor and are configured with the structure around the coil for both waterproofing and electrical connection to the outside, so there was a problem in that the electric water pumps occupied a large amount of space within the apparatus to which they were applied.

Moreover, in some stators of the electric water pumps of the related art, when a coil was wound on the outer side of a stator, the coil had to be stacked in the height direction of the stator in consideration of interference with a lower housing coupled to the stator. However, since the overall length of a product was designed to be large in consideration of the height of the coil stacked in the height direction, and as a result, there was a problem in that the volume increased.

In addition, such a design inevitably resulted in an increase in the number of parts for electrical connection, so there was a problem in that an assembly process and waterproofing became complicated.

### Related Art Document

[Patent Document] KR 10-2015-0052436 A (2015.05.14.)

### SUMMARY

The present disclosure provides an electric water pump with terminal that can be directly electrically connected to a stator including a plurality of coils.

Further, the present disclosure provides an electric water pump that can dispense with a lower housing coupled to an outer side of a stator and allows an outer coil to be stacked in a horizontal direction through a process of overmolding the stator together with a coil.

In one general aspect, an electric water pump with a direct terminal includes a stator including a rotor accommodating portion configured to accommodate a rotor and a plurality of coils arranged in a circumferential direction around a rotational shaft of the rotor; and a terminal coupled to a side of the stator and electrically connected to the plurality of coils, in which the terminal includes a direct terminal interposed inside the stator in direct contact with the plurality of coils.

Further, the terminal may include a conductor coupled to a side of the stator in a direction of the rotational shaft and formed in a circumferential direction, and the direct terminal may extend from the conductor and bend toward the stator to be interposed.

Further, the stator may include a terminal accommodating portion in which a coil terminal, which is a portion of the coil, is exposed and the direct terminal is interposed.

Further, the direct terminal may be formed in the direction of the rotational shaft of the stator and may be interposed in the terminal accommodating portion in the same direction.

Further, the direct terminal may include a first contact portion and a second contact portion that form a V-shaped groove at a location of contact with the coil terminal.

Further, the first contact portion and the second contact portion may further include a backlash that is an empty space formed on an opposite side of a portion, which is in contact with the coil terminal, when the direct terminal is completely fitted in the terminal accommodating portion.

Further, the terminal accommodating portion may include a sealing edge forming a certain angle at both ends of an entrance through which the direct terminal enters, and the direct terminal may further include a sealing portion engaging with the sealing edge at the same angle.

Further, the sealing edge and the sealing portion may be formed in a thickness direction and a width direction of the direct terminal, respectively.

Further, the coil terminal and the terminal accommodating portion may be positioned outside a wound portion of the coil around the rotational shaft of the stator, and the terminal may form a direct terminal corresponding to each coil terminal by being formed in the circumferential direction of the stator.

Further, the coil may further include an outer coil disposed outside the coil terminal and the terminal accommodating portion, and the outer coil may be arranged in the circumferential direction of the stator and electrically connected to the wound portion of the coil.

Further, the outer coil may be wound to be stacked in a direction perpendicular to the rotational shaft of the stator.

Further, the outer coil may be disposed within a range in which the coil is wound, on the basis of the direction of the rotational shaft.

### BRIEF DESCRIPTION OF THE DRAWINGS

FIG. 1 is a side view of an electric water pump according to the present disclosure.

FIG. 2 is a cross-sectional view of the electric water pump according to the present disclosure.

FIG. 3 and FIG. 4 are enlarged views of the electric water pump according to several embodiments of the present disclosure.

FIG. 5 is an enlarged view of the electric water pump according to the present disclosure.

### DETAILED DESCRIPTION OF MAIN ELEMENTS

1: Rotational shaft
10: Electric water pump 11: Rotor accommodating portion
20: Rotor
100: Stator 101: Terminal accommodating portion
102: Sealing edge 103: Protrusion
110: Coil 120: Coil terminal
130: Outer coil
200: Terminal
202: Sealing portion
210: Direct terminal
211: First and second contact portions
212: Backlash
230: External connection portion

### DETAILED DESCRIPTION OF EMBODIMENTS

Hereinafter, the technical spirit of the present disclosure is described in more detail using the accompanying drawings. Prior to this, the terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the invention. Therefore, the configurations described in the embodiments and drawings of the present disclosure are merely most preferable embodiments but do not represent all of the technical spirits of the present disclosure. Thus, it should be understood that the present disclosure should be construed as including all modifications capable of replacing them at the time of filing this application.

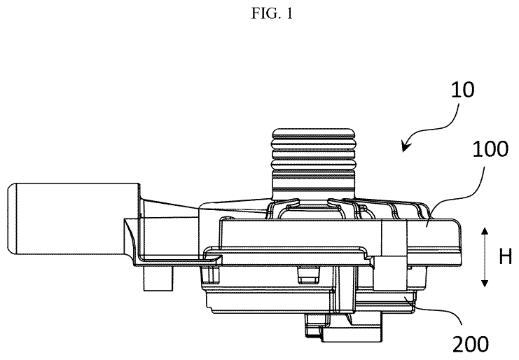

FIG. 1 illustrates the overall appearance of the electric water pump 10 according to the present disclosure. The electric water pump 10 according to an embodiment of the present disclosure may generally include a stator 100 and a terminal 200 connected to electrical components included in the stator 100, as illustrated.

More specifically, the stator 100 can drive the electric water pump 10 in a manner in which a rotor is accommodated and an impeller rotates with rotation of the rotor and moves fluid.

In this configuration, the electric water pump 10 according to the present disclosure is intended to reduce the height H for miniaturization, and the stator 100 and the terminal 200 may be electrically connected and may be directly connected without including an additional components therebetween.

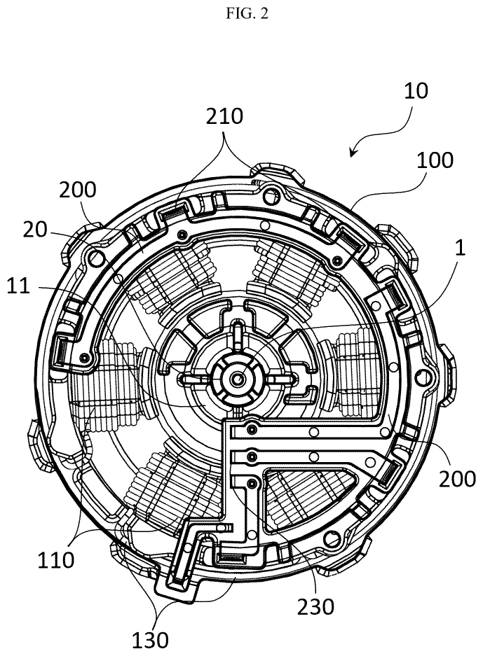

FIG. 2 illustrates a cross section of the electric water pump 10 according to the present disclosure. As illustrated, the electric water pump 10 may include a stator 100 including a rotor accommodating portion 11 that accommodates a rotor 20 and a plurality of coils 110 arranged in a circumferential direction around a rotational shaft 1 of the rotor 20.

In this configuration, the electric water pump 10 may include a terminal 200 that is coupled to a side of the stator 100 and is electrically connected to the plurality of coils 110, and the terminal 200 may include a direct terminal 210 that is interposed inside the stator 100 in direct contact with the plurality of coils 110.

In addition, the terminal 200 may include a conductor coupled to a side of the stator 100 in the direction of the rotational shaft 1 and formed in the circumferential direction, and may include an external connection portion 230 electrically connected to the conductor.

The coils 110, which are for inducing rotational motion of the rotor 20, may be arranged in the circumferential direction around the rotor accommodating portion 11 and may be wound in respective sections. The coils 110 may include a coil terminal 120 exposed to be directly connected to the direct terminal 210 by being connected at a wound portion.

In this configuration, the direct terminal 210 extends from the conductor and bends toward the stator 100 to be interposed, so it can be connected to the coil terminal 120 in contact with the coil terminal 120.

In addition, the coil 110 may further include an outer coil 110 disposed outside the coil terminal 120 around the rotational shaft 1. The outer coil 110 may be formed in the circumferential direction of the stator 100.

That is, the outer coil 110 can provide an electric path to be electrically connected to the plurality of coils 110 wound outside the stator 100 and to other components.

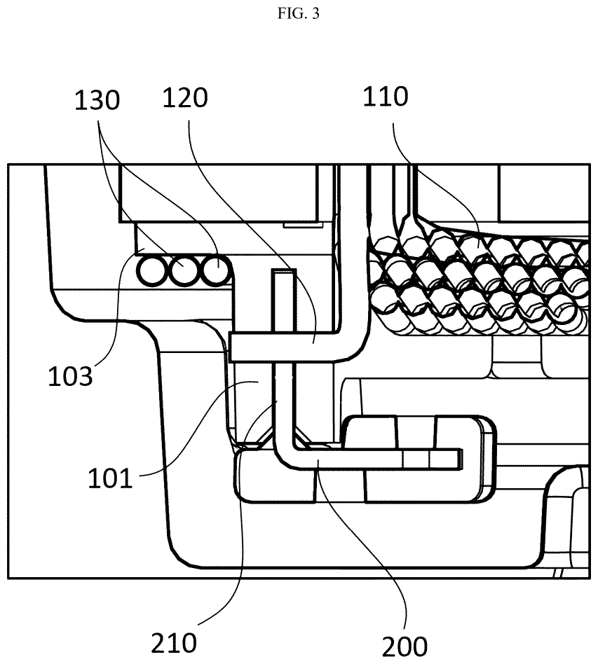

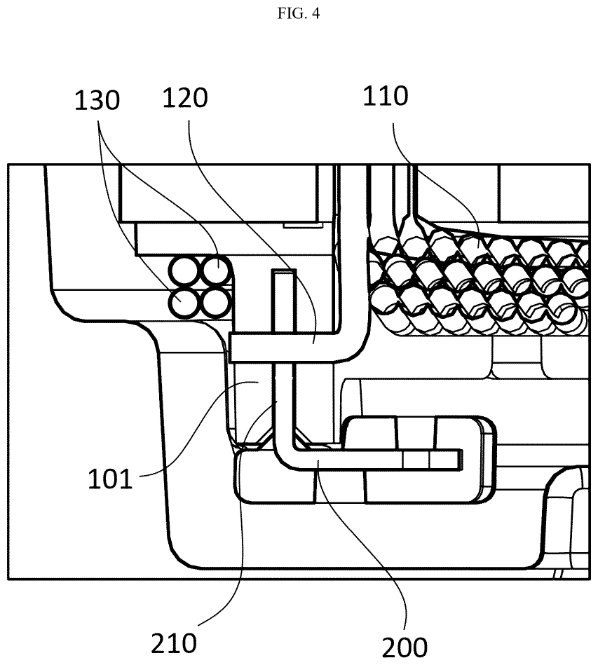

FIG. 3 and FIG. 4 are enlarged views of the electric water pump 10 according to the present disclosure, and are enlarged views of a portion where the terminal 200 and the coil 110 are connected.

As illustrated, the stator 100 may include a terminal accommodating portion 101 in which a coil terminal 120, which is a portion of the coil 110, is exposed and the direct terminal 210 is interposed. The coil terminal 120 may extend from a wound portion of the coil 110 and may be exposed in the terminal accommodating portion 101.

In this configuration, the coil terminal 120 may protrude outward around the rotational shaft 1 of the stator 100, and the exposed portion may be formed outside the wound portion of the coil 110.

Further, the coil terminal 120 may be formed in a direction perpendicular to the rotational shaft 1 of the stator 100. This is for facilitating connection with the direct terminal 210.

Further, the direct terminal 210 may be formed in the direction of the rotational shaft 1 of the stator 100 and may be interposed in the terminal accommodating portion 101 in the same direction.

That is, the terminal accommodating portion 101 is formed on the stator 100 outside the respective winding portions of the coil 110 and is formed to be open in the coupling direction of the terminal 200. The coil terminal 120 is exposed in the terminal accommodating portion 101. The direct terminal 210 extends from the terminal 200 and bends toward the stator 100 to be interposed into the terminal accommodating portion 101, so it can be electrically connected to the coil 110 in contact with the coil 110.

In this configuration, the outer coil 130, as illustrated, may be disposed outside the coil terminal 120 and the terminal accommodating portion 101. Accordingly, electrical connection can be made at a position where the wound portion of the coil 110 is closest to the terminal 200, and the configuration between them can be omitted, so the electric water pump 10 according to the present disclosure has an advantage in that a miniaturized design is possible.

The outer coil 130 may be wound to be stacked in a direction perpendicular to the rotational shaft of the stator 100. That is, since the electric water pump 10 according to the present disclosure aims to minimize its volume as much as possible, the height of the stator 100 can be reduced through the disposition of the outer coil 130.

In other words, the outer coil 130 may be designed to further reduce the height by winding it in a stacked manner in a horizontal direction, which is perpendicular to the rotational shaft rather than being a vertical direction that is the direction of the rotational shaft.

In this configuration, the outer coil 130 may be wound on the outer side of the stator 100 but may be designed to be disposed within the range in which the coil 110 wound inside the stator 100 is disposed. That is, by disposing the outer coil 130 within the unavoidable height formed by the winding of the coil 110, space can be saved and the volume can be minimized.

Referring to FIG. 3, as illustrated, as further described above, the outer coil 130 may be designed to be stacked only in the horizontal direction other than the vertical direction.

In this configuration, the stator 100 may further include a protrusion 103 protruding in the horizontal direction to support the outer coil 130, and the outer coil 130 may be wound to be stacked in the horizontal direction in close contact with the protrusion 103.

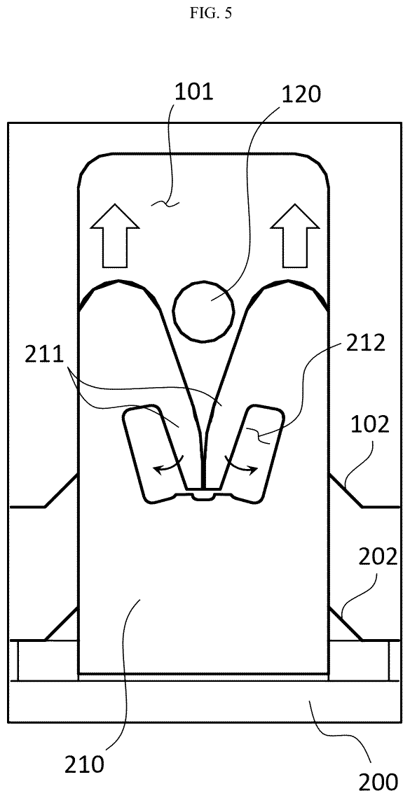

FIG. 5 illustrates, in a further enlarged view, a portion at which the direct terminal 210 of the electric water pump 10 according to the present disclosure is formed.

As illustrated, the direct terminal 210 may be interposed on the terminal accommodating portion 101 formed to be open in the coupling direction of the terminal 200.

In this configuration, the direct terminal 210 may include a first contact portion 211 and a second contact portion 211 that form a V-shaped groove at the location of contact with the coil terminal 120. The coil terminal 120 can be electrically connected to the direct terminal 210 in contact with the direct terminal 210 in a manner that it is fitted in the groove formed by the first contact portion 211 and the second contact portion 211. To this end, it is preferable that the groove formed by the first contact portion 211 and the second contact portion 211 forms a width smaller than the diameter of the coil terminal 120 from a certain depth.

That is, when the direct terminal 210 is completely interposed in the terminal accommodating portion 101, the coil terminal 120 is fastened in a manner that it is fitted between the first contact portion 211 and the second contact portion 211.

In this configuration, the first contact portion 211 and the second contact portion 211 may further include a backlash 212 that is an empty space formed on the opposite side of the portion that is in contact with the coil terminal 120. The backlash 212 is a groove-shaped space, where a portion of the direct terminal 210 is removed, to secure a space in which the first contact portion 211 and the second contact portion 211 are pushed backward by the coil terminal 120. The backlash 212 serves to increase the fastening capability so that the direct terminal 210 can be completely interposed into the terminal accommodating portion 101 upon fitting of the coil terminal 120.

In this configuration, for example, as illustrated, the first contact portion 211 and the second contact portion 211 may be designed to form ends that form a gap inside the V-shaped groove of the direct terminal 210. That is, the ends of the first contact portion 211 and the second contact portion 211 are designed to more freely enter and slide into the backlash 212, so it is possible to further improve the fastening capability of the direct terminal 210.

In addition, the end of the direct terminal 210 that starts to enter the terminal accommodating portion 101 may be designed in a rounded shape. This is for preventing physical damage to the coil terminal 120, which starts to make contact, and as illustrated, the ends of the first contact portion 211 and the second contact portion 211 may be formed in a rounded shape.

Further, the terminal accommodating portion 101 includes a sealing edge 102 that forms a certain angle at both ends of the entrance through which the direct terminal 210 enters, and the direct terminal 210 may further include a sealing portion 202 that engages with the sealing edge 102 at the same angle.

That is, the sealing edge 102 may be a space formed by trimming the corner of the entrance of the terminal accommodating portion 101 to prevent damage when the direct terminal 210 enters, and simultaneously to provide sealing.

In addition, the direct terminal 210 may further include a sealing portion 202 that corresponds to both ends of the portion entering the terminal accommodating portion 101 at the same angle as the sealing edge 102 and can fill the sealing edge 102.

Accordingly, there is an advantage in that when the terminal 200 is fastened to the stator 100 and overmolded together, the molding member enters the terminal accommodating portion 101, whereby it is possible to prevent the fastening from becoming unstable and prevent fluid from entering the inside due to factors such as cracks.

In this configuration, in order to further reinforce this, referring to FIG. 3, the sealing edge 102 and the sealing portion 202 may be formed in the thickness direction and the width direction of the direct terminal 210, respectively, or may be formed to surround the direct terminal 210.The electric water pump according to the present disclosure can minimize the volume through the terminal directly connected to the coils, so it provides the advantage of easy miniaturization of an apparatus.

Further, the electric water pump according to the present disclosure reduces the number of parts required for electrical connection, so it has the advantage of increasing the ease of assembly and simplifying the process.

Further, the electric water pump according to the present disclosure has the advantage of minimizing connection failure by using the shape of the direct terminal.

Further, the electric water pump according to the present disclosure allows the external coil to be stacked in the horizontal direction, so it has the advantage of reducing the overall height of the product and consequently minimizing the overall volume of the product.

What is claimed is:

1. An electric water pump with a direct terminal, comprising:
a stator including a rotor accommodating portion configured to accommodate a rotor and a plurality of coils arranged in a circumferential direction around a rotational shaft of the rotor; and
a terminal coupled to a side of the stator and electrically connected to the plurality of coils,
wherein the terminal includes a direct terminal interposed inside the stator in direct contact with the plurality of coils.

2. The electric water pump of claim 1, wherein the terminal includes a conductor coupled to a side of the stator in a direction of the rotational shaft and formed in a circumferential direction, and
the direct terminal extends from the conductor and bends toward the stator to be interposed.

3. The electric water pump of claim 2, wherein the stator includes a terminal accommodating portion in which a coil terminal, which is a portion of the coil, is exposed and the direct terminal is interposed.

4. The electric water pump of claim 3, wherein the direct terminal is formed in the direction of the rotational shaft of the stator and is interposed in the terminal accommodating portion in the same direction.

5. The electric water pump of claim 4, wherein the direct terminal includes a first contact portion and a second contact portion that form a V-shaped groove at a location of contact with the coil terminal.

6. The electric water pump of claim 5, wherein the first contact portion and the second contact portion further include a backlash that is an empty space formed on a opposite side of a portion, which is in contact with the coil terminal, when the direct terminal is completely fitted in the terminal accommodating portion.

7. The electric water pump of claim 4, wherein the terminal accommodating portion includes a sealing edge forming a certain angle at both ends of an entrance through which the direct terminal enters, and
the direct terminal further includes a sealing portion engaging with the sealing edge at the same angle.

8. The electric water pump of claim 7, wherein the sealing edge and the sealing portion are formed in a thickness direction and a width direction of the direct terminal, respectively.

9. The electric water pump of claim 4, wherein the coil terminal and the terminal accommodating portion are positioned outside a wound portion of the coil around the rotational shaft of the stator, and
the terminal forms a direct terminal corresponding to each coil terminal by being formed in the circumferential direction of the stator.

10. The electric water pump of claim 9, wherein the coil further includes an outer coil disposed outside the coil terminal and the terminal accommodating portion, and
the outer coil is arranged in the circumferential direction of the stator and electrically connected to the wound portion of the coil.

11. The electric water pump of claim 10, wherein the outer coil is wound to be stacked in a direction perpendicular to the rotational shaft of the stator.

12. The electric water pump of claim 11, wherein the outer coil is disposed within a range in which the coil is wound, on the basis of the direction of the rotational shaft.
